(19) United States
(12) Patent Application Publication
(10) Pub. No.: US 2025/0273828 A1
(43) Pub. Date: Aug. 28, 2025

(54) Power Storage Device and Vehicle

(71) Applicant: TOYOTA JIDOSHA KABUSHIKI KAISHA, Toyota-shi Aichi-ken (JP)

(72) Inventor: Nobuo MATSUI, Seto-shi Aichi-ken (JP)

(73) Assignee: TOYOTA JIDOSHA KABUSHIKI KAISHA, Toyota-shi Aichi-ken (JP)

(21) Appl. No.: 19/062,624

(22) Filed: Feb. 25, 2025

(30) Foreign Application Priority Data
Feb. 27, 2024 (JP) 2024-027122

(51) Int. Cl. H01M 50/555; B60R 16/04; H01M 4/02; H01M 10/0583; H01M 50/249

(52) U.S. Cl. CPC H01M 50/555; B60R 16/04; H01M 10/0583; H01M 50/249; H01M 2004/029; H01M 2220/20

(57) ABSTRACT

A power storage device includes a stacked electrode assembly and a seal member. An electrode plate (bipolar electrode) having a positive electrode layer and a negative electrode layer is stacked between a positive-electrode termination electrode and a negative-electrode termination electrode with a separator being interposed between the electrode plate and each of the positive-electrode termination electrode and the negative-electrode termination electrode so as to form a stacked electrode assembly. An uncoated portion of the negative-electrode termination electrode (current collector) and an uncoated portion of the electrode plate (current collector) extend in a stacking direction of the stacked electrode assembly together with the separator adjacent to each of the uncoated portions, and are folded so as to be stacked on the positive-electrode termination electrode with the separator being interposed between each of the uncoated portions and the positive-electrode termination electrode, thereby forming a crushing-time discharging portion.

### CROSS REFERENCE TO RELATED APPLICATIONS

This nonprovisional application is based on Japanese Patent Application No. 2024-027122 filed on Feb. 27, 2024 with the Japan Patent Office, the entire contents of which are hereby incorporated by reference.

### BACKGROUND

### Field

The present disclosure relates to a power storage device and a vehicle.

### Description of the Background Art

Japanese Patent Laying-Open No. 2023-152023 discloses a power storage device including a bipolar electrode in which an active material layer is provided on one surface (first surface) and the other surface (second surface) of a current collector. In Japanese Patent Laying-Open No. 2023-152023, a bipolar battery is constituted by a stacked electrode assembly in which bipolar electrodes are stacked with separators being interposed therebetween.

When a large force is externally applied to the power storage device and the separator of the stacked electrode assembly breaks, a short circuit occurs inside the stacked electrode assembly to generate heat, and the temperature of the power storage device may excessively rise.

### SUMMARY

An object of the present disclosure is to suppress an excessive temperature rise of a power storage device by enabling discharge of the power storage device before a short circuit occurs inside a stacked electrode assembly when large force is applied to the power storage device from outside.

A power storage device according to an embodiment of the present disclosure includes a positive-electrode termination electrode, a negative-electrode termination electrode, and a stacked electrode assembly. The positive-electrode termination electrode has a current collector having one surface on which a positive electrode active material layer is formed and has an uncoated portion on which the positive electrode active material layer is not formed. The negative-electrode termination electrode has a current collector having one surface on which a negative electrode active material layer is formed and has an uncoated portion on which the negative electrode active material layer is not formed. The stacked electrode assembly has a bipolar electrode stacked between the positive-electrode termination electrode and the negative-electrode termination electrode with a separator being interposed between the bipolar electrode and each of the positive-electrode termination electrode and the negative-electrode termination electrode. The bipolar electrode has a current collector having one surface and the other surface on which the positive electrode active material layer and the negative electrode active material layer are formed respectively, and has an uncoated portion on which each of the positive electrode active material layer and the negative electrode active material layer is not formed. The uncoated portion of one of the positive-electrode termination electrode and the negative-electrode termination electrode extends in a stacking direction of the stacked electrode assembly together with the separator adjacent to the uncoated portion of the one of the positive-electrode termination electrode and the negative-electrode termination electrode, and is folded so as to overlap with the other of the positive-electrode termination electrode and the negative-electrode termination electrode with the separator being interposed between the uncoated portion of the one of the positive-electrode termination electrode and the negative-electrode termination electrode and the other of the positive-electrode termination electrode and the negative-electrode termination electrode. The uncoated portion of the other of the positive-electrode termination electrode and the negative-electrode termination electrode and the uncoated portion of the bipolar electrode extend in the stacking direction of the stacked electrode assembly together with the separator adjacent to each of the uncoated portion of the other of the positive-electrode termination electrode and the negative-electrode termination electrode and the uncoated portion of the bipolar electrode, and are folded so as to be stacked on the one of the positive-electrode termination electrode and the negative-electrode termination electrode with the separator being interposed between each of the uncoated portion of the other of the positive-electrode termination electrode and the negative-electrode termination electrode and the uncoated portion of the bipolar electrode and the one of the positive-electrode termination electrode and the negative-electrode termination electrode.

According to the above configuration, the bipolar battery is formed by the stacked electrode assembly having the bipolar electrode stacked between the positive-electrode termination electrode and the negative-electrode termination electrode with the separator being interposed between the bipolar electrode and each of the positive-electrode termination electrode and the negative-electrode termination electrode. Each of the bipolar electrode, the positive-electrode termination electrode, and the negative-electrode termination electrode has the uncoated portion on which none of the positive electrode active material layer and the negative electrode active material layer is formed. The uncoated portion of the one of the positive-electrode termination electrode and the negative-electrode termination electrode extends in the stacking direction of the stacked electrode assembly together with the separator adjacent to the uncoated portion of the one of the positive-electrode termination electrode and the negative-electrode termination electrode, and is folded so as to overlap with the other of the positive-electrode termination electrode and the negative-electrode termination electrode with the separator being interposed between the uncoated portion of the one of the positive-electrode termination electrode and the negative-electrode termination electrode and the other of the positive-electrode termination electrode and the negative-electrode termination electrode. The uncoated portion of the other of the positive-electrode termination electrode and the negative-electrode termination electrode and the uncoated portion of the bipolar electrode extend in the stacking direction of the stacked electrode assembly together with the separator adjacent to each of the uncoated portion of the other of the positive-electrode termination electrode and the negative-electrode termination electrode and the uncoated portion of the bipolar electrode, and are folded so as to be stacked on the one of the positive-electrode termination electrode and the negative-electrode termination electrode with the separator being interposed between each of the uncoated portion of the other of the positive-electrode termination electrode and the negative-electrode termination electrode and the uncoated portion of the bipolar electrode and the one of the positive-electrode termination electrode and the negative-electrode termination electrode.

When the uncoated portion of the one is that of the positive-electrode termination electrode, the uncoated portion of the positive-electrode termination electrode is folded so as to overlap with the negative-electrode termination electrode with the separator being interposed between the uncoated portion of the positive-electrode termination electrode and the negative-electrode termination electrode, and the uncoated portion of the negative-electrode termination electrode and the uncoated portion of the bipolar electrode are folded so as to be stacked on the positive-electrode termination electrode with the separator being interposed between each of the uncoated portion of the negative-electrode termination electrode and the uncoated portion of the bipolar electrode and the positive-electrode termination electrode. In this case, the region in which the uncoated portion of the negative-electrode termination electrode and the uncoated portion of the bipolar electrode are folded so as to be stacked on the positive-electrode termination electrode with the separator being interposed therebetween functions as a crushing-time discharging portion in which the current collector of the negative-electrode termination electrode and the current collector of the bipolar electrode are stacked with the separator being interposed therebetween.

When the uncoated portion of the one is that of the negative-electrode termination electrode, the uncoated portion of the negative-electrode termination electrode is folded so as to overlap with the positive-electrode termination electrode with the separator being interposed between the negative-electrode termination electrode and the positive-electrode termination electrode, and the uncoated portion of the positive-electrode termination electrode and the uncoated portion of the bipolar electrode are folded so as to be stacked on the negative-electrode termination electrode with the separator being interposed between each of the uncoated portion of the positive-electrode termination electrode and the uncoated portion of the bipolar electrode and the negative-electrode termination electrode. In this case, the region in which the uncoated portion of the positive-electrode termination electrode and the uncoated portion of the bipolar electrode are folded so as to be stacked on the negative-electrode termination electrode with the separator being interposed therebetween functions as a crushing-time discharging portion in which the current collector of the positive-electrode termination electrode and the current collector of the bipolar electrode are stacked with the separator being interposed therebetween.

When large force is applied to the power storage device from outside, the separator in the region functioning as the crushing-time discharging portion breaks and a short circuit occurs before the separator inside the stacked electrode assembly breaks and a short circuit occurs, and discharge occurs outside the stacked electrode assembly. Thus, the SOC (State Of Charge) of the stacked electrode assembly is decreased, thereby suppressing an excessive temperature rise of the power storage device.

A thickness of the separator in a region folded so as to be stacked on the one of the positive-electrode termination electrode and the negative-electrode termination electrode may be thinner than a thickness of the separator in a region included in the stacked electrode assembly.

According to this configuration, since the thickness of the separator in the region functioning as the crushing-time discharging portion is thinner than the thickness of the separator in the region included in the stacked electrode assembly, the separator in the region functioning as the crushing-time discharging portion is likely to break before the separator inside the stacked electrode assembly breaks when large force is applied to the power storage device from outside. Therefore, an excessive temperature rise of the power storage device can be suppressed more suitably.

A vehicle according to the present disclosure is a vehicle on which the power storage device is mounted. The power storage device is mounted on a floor of the vehicle. The power storage device may be disposed such that a side of the power storage device on which the uncoated portion of the other of the positive-electrode termination electrode and the negative-electrode termination electrode and the uncoated portion of the bipolar electrode are folded to be stacked on the one of the positive-electrode termination electrode and the negative-electrode termination electrode with the separator being interposed between the uncoated portion of the other of the positive-electrode termination electrode and the negative-electrode termination electrode and the uncoated portion of the bipolar electrode faces a road surface.

According to this configuration, the power storage device is mounted on the floor of the vehicle. Since the side of the power storage device that functions as the crushing-time discharging portion is disposed in the direction facing the road surface, the separator in the region functioning as the crushing-time discharging portion is likely to break before the separator inside the stacked electrode assembly breaks when the floor of the vehicle receives large force due to an interference with the road surface or the like. Therefore, an excessive temperature rise of the power storage device can be suppressed more suitably.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a schematic cross-sectional view of a power storage device according to the present embodiment.

FIG. 2 is a schematic partial cross-sectional view of the power storage device according to the present embodiment.

FIG. 3 is a diagram illustrating a function of a crushing-time discharging portion.

FIG. 4A illustrates a perspective view of a battery module in which a power storage device is housed in an exterior package.

FIG. 4B illustrates cross-sectional view of a battery module in which a power storage device is housed in an exterior package taken along the line B-B of FIG. 4A.

FIG. 5A illustrates a perspective view showing a bipolar battery module which is connected in series with the battery module to form a battery assembly.

FIG. 5B illustrates a cross-sectional view showing a bipolar battery module which is connected in series with the battery module to form a battery assembly taken along the lone B-B of FIG. 5A.

FIG. 6A illustrates a battery pack including a battery module and a bipolar battery module.

FIG. 6B illustrates a battery pack including a battery module and a bipolar battery module mounted in a vehicle.

### DESCRIPTION OF THE EMBODIMENTS

Hereinafter, embodiments of the present disclosure will be described in detail with reference to the drawings. In the following embodiments, the same or common parts are denoted by the same reference numerals in the drawings, and the description thereof will not be repeated. In the drawings, in order to facilitate understanding of the structure, the ratio may be changed so as to make the structure clear.

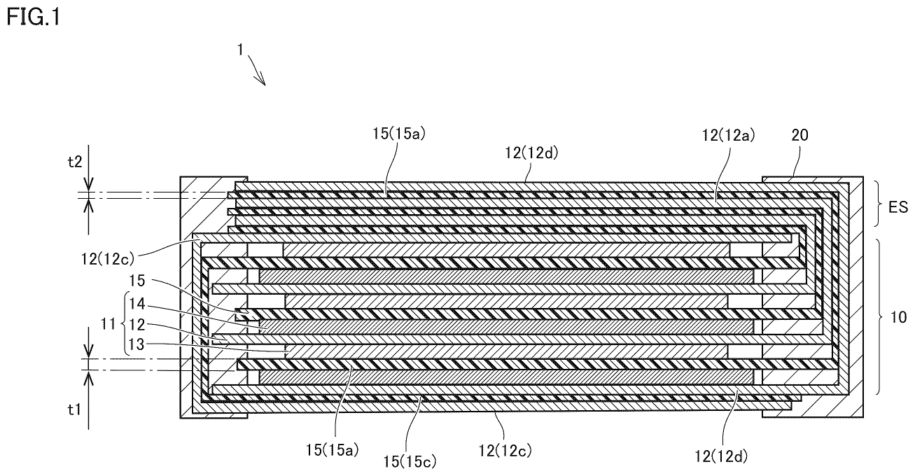

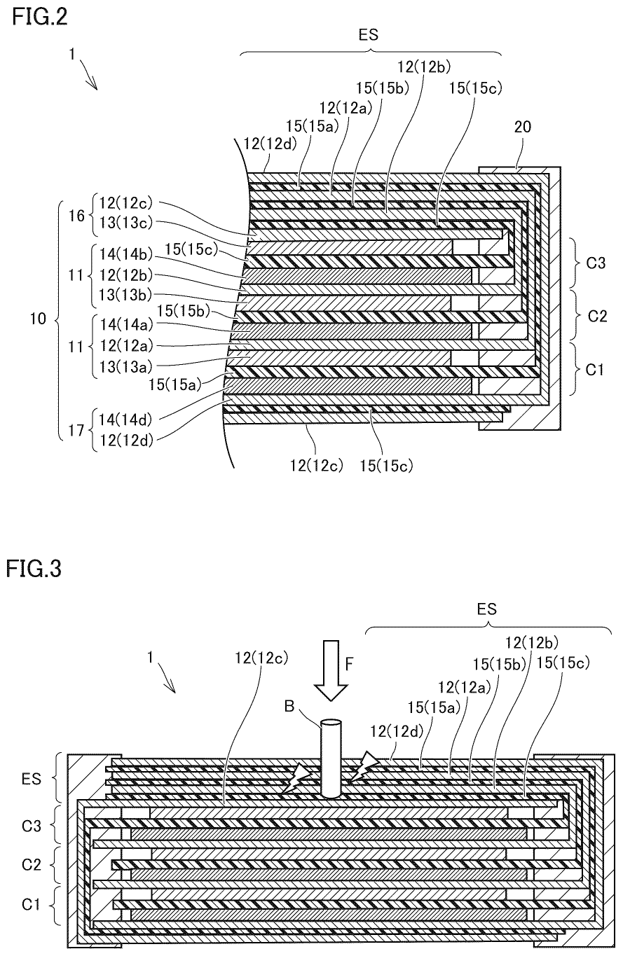

FIG. 1 is a schematic cross-sectional view of a power storage device according to the present embodiment. FIG. 2 is a schematic partial cross-sectional view of the power storage device according to the present embodiment. Note that FIG. 2 is a diagram in which a part of FIG. 1 is removed for ease of explanation using reference numerals.

Referring to FIG. 2, power storage device 1 includes stacked electrode assembly 10 and seal member 20. The power storage device 1 is, for example, a secondary battery such as a lithium ion battery. The stacked electrode assembly 10 includes a plurality of electrode plates 11, a plurality of separators 15, a positive-electrode termination electrode 16, and a negative-electrode termination electrode 17. The plurality of electrode plates 11, the positive-electrode termination electrode 16, and the negative-electrode termination electrode 17 are stacked with the separator 15 interposed therebetween. The direction in which the stacked electrode assembly 10 is stacked is referred to as a “stacking direction”.

The separator 15 is formed in a sheet shape. Examples of the separator 15 include a porous film made of a polyolefin-based resin such as polyethylene (PE) or polypropylene (PP), and a woven fabric or a nonwoven fabric made of polypropylene, methyl cellulose, or the like. The separator 15 may be reinforced with a vinylidene fluoride resin compound.

The plurality of electrode plates 11 are provided between the positive-electrode termination electrode 16 and the negative-electrode termination electrode 17. The electrode plate 11 includes a current collector 12, a positive electrode layer 13, and a negative electrode layer 14. The electrode plate 11 is a bipolar electrode.

The current collector 12 may contain, for example, at least one selected from the group consisting of aluminum (Al), stainless steel, nickel (Ni), chromium (Cr), platinum (Pt), niobium (Nb), iron (Fe), titanium (Ti), copper (Cu), and zinc (Zn). The current collector 12 may be formed by plating the surface of a metal foil.

The current collector 12 has a first main surface located on one side in the stacking direction and a second main surface located on the other side in the stacking direction. The negative electrode layer 14 is provided on the first main surface. The positive electrode layer 13 is provided on the second main surface.

The current collectors 12a and 12b of the electrode plate 11 may have a two-layer structure in which a current collector for the positive electrode layer 13 and a current collector for the negative electrode layer 14 are superposed on each other. In this case, the current collector for the positive electrode layer 13 may be made of aluminum (Al), and the current collector for the negative electrode layer 14 may be made of nickel (Ni).

The positive-electrode termination electrode 16 is located on one side in the stacking direction. The positive-electrode termination electrode 16 includes a current collector 12 and a positive electrode layer 13. In the positive-electrode termination electrode 16, the negative electrode layer 14 and the positive electrode layer 13 are not provided on the first main surface located on one side of the current collector 12, and the positive electrode layer 13 is provided on the second main surface located on the other side of the current collector 12.

The negative-electrode termination electrode 17 is located on the other side in the stacking direction. The negative-electrode termination electrode 17 includes a current collector 12 and a negative electrode layer 14. In the negative-electrode termination electrode 17, the negative electrode layer 14 is provided on the first type surface located on one side of the current collector 12, and the negative electrode layer 14 and the positive electrode layer 13 are not provided on the second main surface located on the other side of the current collector 12.

The positive electrode layer 13 is formed by applying a positive electrode active material to the second main surface. As the positive electrode active material, for example, a material capable of occluding and releasing charge carriers such as lithium ions can be employed. The positive electrode active material may include olivine type lithium iron phosphate (LiFePO₄). The positive electrode layer 13 corresponds to the “positive electrode active material layer” of the present disclosure.

The negative electrode layer 14 is formed by applying a negative electrode active material to the first main surface. As the negative electrode parent material, for example, lithium, carbon, a metal compound, an element capable of alloying with lithium, or a compound thereof may be employed. The negative electrode layer 14 corresponds to the “negative electrode active material layer” of the present disclosure.

In any of the plurality of electrode plates 11, the negative-electrode termination electrode 17, and the positive-electrode termination electrode 16, the peripheral edge portion of the current collector 12 is an uncoated region where the positive electrode layer 13 and the negative electrode layer 14 are not provided. The uncoated region is also referred to as an “uncoated portion”.

In the present embodiment, two electrode plates 11 (bipolar electrodes) are stacked between the positive-electrode termination electrode 16 and the negative-electrode termination electrode 17 with the separator 15 being interposed therebetween. The stacked electrode assembly 10 includes a first battery cell C1, a second battery cell C2, and a third battery cell C3. The first battery cell C1 includes the negative-electrode termination electrode 17 (the current collector 12d and the negative electrode layer 14d), the current collector 12a and the positive electrode layer 13a of the electrode plate 11 (the bipolar electrode), and the separator 15a. The second battery cell C2 includes a current collector 12a and a negative electrode layer 14a of the electrode plate 11, a current collector 12b and a positive electrode layer 13b of the electrode plate 11, and a separator 15b. The third battery cell C3 includes the positive-electrode termination electrode 16 (the current collector 12c and the positive electrode layer 13c), the current collector 12b and the negative electrode layer 14b of the electrode plate 11 (the bipolar electrode), and the separator 15c. The number of stacked electrode plates 11 may be three or more.

In the uncoated portion of the current collector 12c of the positive-electrode termination electrode 16 and the adjacent separator 15c, an extended portion extending in the stacking direction of the stacked electrode assembly 10 is formed on the left side in FIG. 1. The extended portion is folded so as to overlap the current collector 12d of the negative-electrode termination electrode 17. Thus, the current collector 12c of the positive-electrode termination electrode 16 overlaps the current collector 12d of the negative-electrode termination electrode 17 with the adjacent separator 15c being interposed therebetween.

In the uncoated portion of the current collector 12b of the electrode plate 11 adjacent to the positive-electrode termination electrode 16 and the adjacent separator 15c, an extended portion extending in the stacking direction of the stacked electrode assembly 10 is formed on the right side in FIG. 1. The extended portion is folded so as to overlap the current collector 12c of the positive-electrode termination electrode 16. Thus, the current collector 12b of the electrode plate 11 overlaps the current collector 12c of the positive-electrode termination electrode with the adjacent separator 15c being interposed therebetween.

In the uncoated portion of the current collector 12a of the electrode plate 11 adjacent to the negative-electrode termination electrode 17 and the adjacent separator 15b, an extended portion extending in the stacking direction of the stacked electrode assembly 10 is formed on the right side in FIG. 1. The extended portion is folded so as to overlap the current collector 12b of the electrode plate 11. Thus, the current collector 12a of the electrode plate 11 overlaps with the current collector 12b with the adjacent separator 15b being interposed therebetween.

In the uncoated portion of the current collector 12d of the negative-electrode termination electrode 17 and the adjacent separator 15a, an extended portion extending in the stacking direction of the stacked electrode assembly 10 is formed on the right side in FIG. 1. The extended portion is folded so as to overlap the current collector 12a of the electrode plate 11. Thus, the current collector 12d of the negative-electrode termination electrode 17 overlaps the current collector 12a of the electrode plate 11 with the adjacent separator 15a being interposed therebetween.

As described above, the uncoated portions of the negative-electrode termination electrode 17 and the electrode plate 11 extend in the stacking direction of the stacked electrode assembly 10 together with the adjacent separators 15, and are folded so as to be stacked on the positive-electrode termination electrode 16 with the separators 15 being interposed therebetween. A region in which the negative-electrode termination electrode 17 and the uncoated portion of the electrode plate 11 are folded so as to be stacked on the positive-electrode termination electrode 16 with the separator 15 interposed therebetween is also referred to as a “crushing-time discharging portion ES”.

The seal member 20 is provided so as to seal the periphery of the stacked electrode assembly 10 and the extension portion extending in the stacking direction of the current collector 12 and the separator 15. The seal member 20 seals an internal space formed between the adjacent electrode plates 11, an internal space formed between the positive-electrode termination electrode 16 and the electrode plate 11, and an internal space formed between the negative-electrode termination electrode 17 and the electrode plate 11. An electrolyte solution is injected into these internal spaces. The seal member 20 is formed by curing a resin member such as a hot melt member, a thermoplastic resin, a thermosetting resin, or a photocurable resin.

In the power storage device 1 configured as described above, the current collector 12c of the positive-electrode termination electrode 16 overlapping the current collector 12d with the separator 15c being interposed therebetween functions as a positive electrode terminal region. The current collector 12d of the negative-electrode termination electrode 17 overlapping the current collector 12a with the separator 15a being interposed therebetween functions as a negative electrode terminal region.

When a large force is externally applied to the power storage device 1 and the separator 15 of the stacked electrode assembly 10 is broken (film ruptured), a short circuit occurs inside the stacked electrode assembly 10 to generate heat, and the temperature of the power storage device 1 may excessively rise.

In the present embodiment, by forming the crushing-time discharging portion ES, when a large force is applied to the power storage device 1 from the outside, the power storage device 1 can be discharged before a short circuit occurs inside the stacked electrode assembly 10, and an excessive temperature rise of the power storage device 1 can be suppressed.

FIG. 3 is a diagram for explaining the function of the crushing-time discharging portion ES. In FIG. 3, the round bar (cylindrical column) B is pressed against the crushing-time discharging portion ES of the power storage device 1 by the external force F. The crushing-time discharging portion ES is a region in which the negative-electrode termination electrode 17 and the uncoated portion of the electrode plate 11 are folded so as to be stacked on the positive-electrode termination electrode 16 with the separator 15 interposed therebetween. Therefore, as the round bar B progresses due to the external force F, before the separator 15 inside the stacked electrode assembly 10 breaks to cause a short circuit, the separator 15 located in the crushing-time discharging portion ES breaks to cause a short circuit, and discharge is performed outside the stacked electrode assembly 10.

For example, with the progress of the round bar B by the external force F, the separator 15a breaks and a short circuit occurs between the current collector 12d and the current collector 12a in the crushing-time discharging portion ES, and the forced discharge of the first battery cell C1 is performed outside the stacked electrode assembly 10. As a result, the SOC of the first battery cell C1 decreases. When the round bar B advances, the separator 15b breaks and a short circuit occurs between the current collector 12a and the current collector 12b in the crushing-time discharging portion ES, and the forced discharge of the second battery cell C2 is performed outside the stacked electrode assembly 10. When the round bar B further progresses, the separator 15c breaks and a short circuit occurs between the current collector 12b and the current collector 12c in the crushing-time discharging portion ES, and the forced discharge of the third battery cell C3 is performed outside the stacked electrode assembly 10.

As described above, when a large force is applied to the power storage device 1 from the outside, before the separator 15 inside the stacked electrode assembly 10 breaks to cause a short circuit, the separator 15 in the region of the crushing-time discharging portion ES breaks to cause a short circuit, and discharge is performed outside the stacked electrode assembly 10. As a result, the SOC of the stacked electrode assembly 10 decreases, and thus an excessive temperature rise of the power storage device 1 can be suppressed.

In the present embodiment, as shown in FIG. 1, the separator 15 is configured such that the thickness t2 of the region of the crushing-time discharging portion ES is thinner than the thickness t1 of the region included in the stacked electrode assembly 10. Since the thickness t2 is smaller than the thickness t1, before the separator 15 inside the stacked electrode assembly 10 breaks and a short circuit occurs when a large force is applied to the power storage device 1 from the outside, the separator 15 in the region of the crushing-time discharging portion ES easily breaks, and discharge outside the stacked electrode assembly 10 can be performed more reliably.

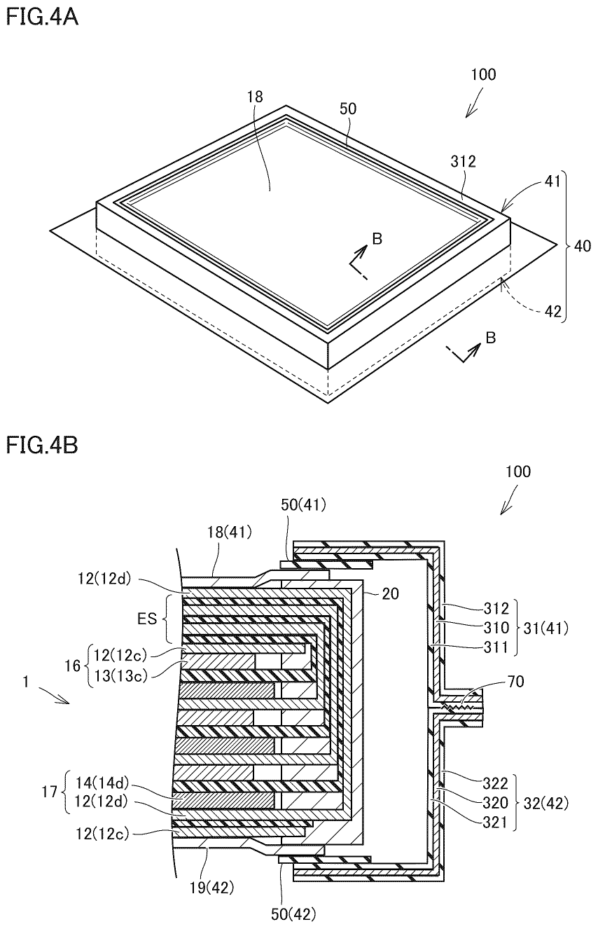

Each of FIGS. 4A and 4B is a diagram illustrating the battery module 100 in which the power storage device 1 is housed in the exterior package 40. The battery module 100 is formed by housing the power storage device 1 in the exterior package 40. FIG. 4A is a perspective view of the battery module 100, and FIG. 4B is a cross-sectional view taken along line B-B in FIG. 4A. The exterior package 40 includes an exterior package A 41 and an exterior package B 42. The A exterior package 41 and the B exterior package 42 seal the power storage device 1 inside by joining their peripheral edge portions to each other. The A exterior package 41 is disposed on the current collector 12d of the negative-electrode termination electrode 17 located on one side in the stacking direction (on the crushing-time discharging portion ES side). The B exterior package 42 is disposed on the current collector 12c of the positive-electrode termination electrode 16 located on the other side in the stacking direction.

The A exterior package 41 includes the first conductive plate 18, the resin layer 50, and the first sheet member 31. The B exterior package 42 includes the second conductive plate 19, the resin layer 50, and the second sheet member 32.

The first conductive plate 18 and the second conductive plate 19 are provided so as to sandwich the power storage device 1 in the stacking direction. The first conductive plate 18 is disposed on the current collector 12d of the negative-electrode termination electrode 17. The first conductive plate 18 is electrically connected to the negative-electrode termination electrode 17 by being disposed in contact with the current collector 12d. The first conductive plate 18 functions as a negative terminal of the battery module 100 by being electrically connected to the negative-electrode termination electrode 17. The second conductive plate 19 is disposed on the current collector 12c of the positive-electrode termination electrode 16. The second conductive plate 19 is electrically connected to the positive-electrode termination electrode 16 by being disposed in contact with the current collector 12c. The second conductive plate 19 functions as a positive electrode terminal of the battery module 100 by being electrically connected to the positive-electrode termination electrode 16. In the battery module 100, the current can be extracted to the outside from the power storage device 1 accommodated therein via the first conductive plate 18 functioning as the negative electrode terminal and the second conductive plate 19 functioning as the positive electrode terminal without using a tab for extracting the current to the outside.

The first sheet member 31 constitutes a peripheral edge portion of the exterior package A 41. The first sheet member 31 is bonded to the peripheral edge of the first conductive plate 18. In the present embodiment, the first sheet member 31 is bonded to the first conductive plate 18 in a state where the resin layer 50 is interposed between the first sheet member and the peripheral edge of the first conductive plate 18.

The second sheet member 32 constitutes a peripheral edge portion of the B exterior package 42. The second sheet member 32 is bonded to the peripheral edge of the second conductive plate 19. In the present embodiment, the second sheet member 32 is bonded to the second conductive plate 19 in a state where the resin layer 50 is interposed between the second sheet member and the peripheral edge of the second conductive plate 19.

The peripheral edges of the first conductive plate 18 and the second conductive plate 19 are located on the seal member 20. A resin material having an insulating property may be used for the resin layer 50. As the resin layer 50, a resin material that can be welded to the first conductive plate 18 or the second conductive plate 19 may be used. As the resin layer 50, for example, a heat-fusible resin such as polyethylene, polypropylene, modified polyethylene, or modified polypropylene can be employed.

In the present embodiment, the first sheet member 31 and the second sheet member 32 are laminate films. The first sheet member 31 includes a first metal layer 310, a first insulating layer 311, and a second insulating layer 312. As the first metal layer 310, for example, a metal foil such as an Al foil, a Ni foil, a Cu foil, or a stainless steel foil can be used. The first insulating layer 311 and the second insulating layer 312 may be made of a heat-sealable resin such as polyethylene, polypropylene, modified polyethylene, or modified polypropylene. The second insulating layer 312 may be a member different from the first insulating layer 311. As the second insulating layer 312, for example, a single layer of polyethylene terephthalate or nylon, or a stacked layer thereof may be employed. The first insulating layer 311 and the second insulating layer 312 may be formed of one layer or may have a multilayer structure.

The second sheet member 32 includes a second metal layer 320, a first insulating layer 321, and a second insulating layer 322. The second metal layer 320, the first insulating layer 321, and the second insulating layer 322 may be the same as those of the first metal layer 310, the first insulating layer 311, and the second insulating layer 312.

The first sheet member 31 of the A exterior package 41 and the outer peripheral portion of the second sheet member 32 of the B exterior package 42 are joined by welding. Thus, the power storage device 1 is sealed in the A exterior package 41 and the B exterior package 42 by welding the first insulating layer 311 of the A exterior package 41 and the first insulating layer 321 of the B exterior package 42 in a state of facing each other. A welded portion 70 is formed in an outer peripheral portion where the A exterior package 41 and the B exterior package 42 are welded.

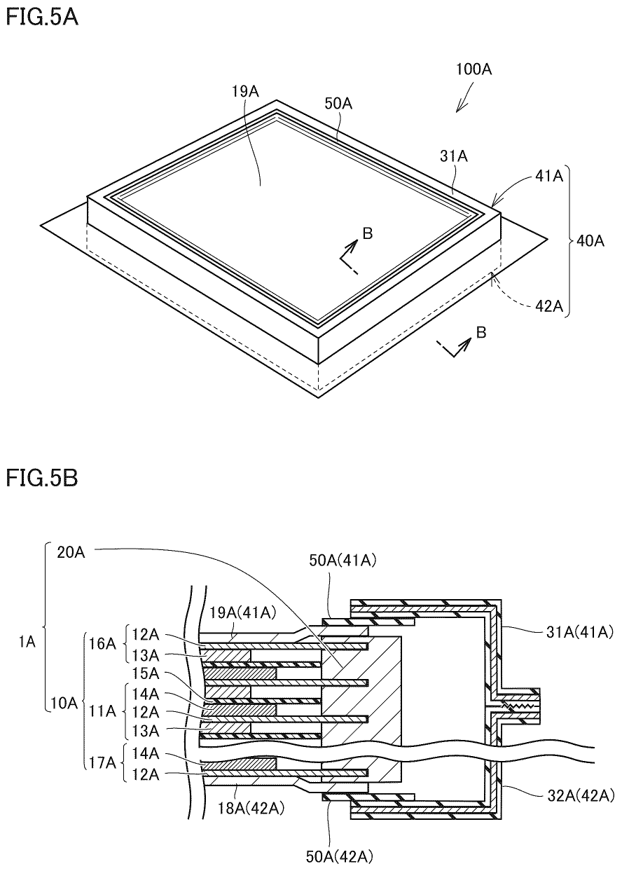

Each of FIGS. 5A and 5B is a diagram showing a bipolar battery module 100A that is connected in series with the battery module 100 of the present embodiment to form a battery assembly. FIG. 5A is a perspective view of the bipolar battery module 100A, and FIG. 5B is a cross-sectional view taken along line B-B shown in FIG. 5A. The bipolar battery module 100A has substantially the same configuration as that of the battery module 100 of FIGS. 4A and 4B except that the crushing-time discharging portion ES is omitted. The bipolar battery module 100A includes a power storage unit 1A having a stacked electrode assembly 10A and a seal member 20A, and an exterior package 40A that accommodates the power storage unit 1A.

The stacked electrode assembly 10A includes a plurality of electrode plates 11A, a plurality of separators 15A, a positive-electrode termination electrode 16A, and a negative-electrode termination electrode 17A. The plurality of electrode plates 11A, the positive-electrode termination electrode 16A, and the negative-electrode termination electrode 17A are stacked in the stacking direction with the separator 15A interposed therebetween. The number of the electrode plates 11A is any number, and may be, for example, 5, 20, or 30.

The electrode plate 11A is substantially the same as the electrode plate 11, and a positive electrode layer 13A is formed on one surface of the current collector 12A, and a negative electrode layer 14A is formed on the other surface of the current collector 12A. The current collector 12A, the positive electrode layer 13A, and the negative electrode layer 14A are substantially the same as the positive electrode layer 13 and the negative electrode layer 14 described above, and the electrode plate 11A is a bipolar electrode.

The separator 15A, the positive-electrode termination electrode 16A, and the negative-electrode termination electrode 17A are substantially the same as the separator 15, the positive-electrode termination electrode 16, and the negative-electrode termination electrode 17, respectively.

In any of the plurality of electrode plates 11A, the positive-electrode termination electrode 16A, and the negative-electrode termination electrode 17A, the uncoated portion of the peripheral edge portion of the current collector 12A does not have an extended portion extending in the stacking direction of the stacked electrode assembly 10. Also, the separator 15A is not provided with an extension portion extending in the stacking direction of the stacked electrode assembly 10.

The seal member 20A is provided so as to seal the periphery of the stacked electrode assembly 10A. The seal member 20A seals an internal space formed between the adjacent electrode plates 11A, an internal space formed between the positive-electrode termination electrode 16A and the electrode plate 11A, and an internal space formed between the negative-electrode termination electrode 17A and the electrode plate 11A. An electrolyte solution is injected into these internal spaces. The exterior package 40A includes an exterior package 41A and an exterior package 42A. The exterior package 41A includes a conductive plate 19A, a resin layer 50A, and a sheet member 31A. The exterior package 42A includes a conductive plate 18A, a resin layer 50A, and a sheet member 32A.

The conductive plate 18A and the conductive plate 19A are provided so as to sandwich the stacked electrode assembly 10A in the stacking direction. The conductive plate 19A is electrically connected to the positive-electrode termination electrode 16A by being disposed on and in contact with the current collector 12A of the positive-electrode termination electrode 16A. The conductive plate 19A functions as a positive electrode terminal of the bipolar battery module 100A. The conductive plate 18A is electrically connected to the negative-electrode termination electrode 17A by being disposed in contact with the current collector 12A of the negative-electrode termination electrode 17A. The conductive plate 18A functions as a negative electrode terminal of the bipolar battery module 100A. Since the other configuration of the exterior package 40A is the same as that of the exterior package 40 described above, the description thereof will be omitted.

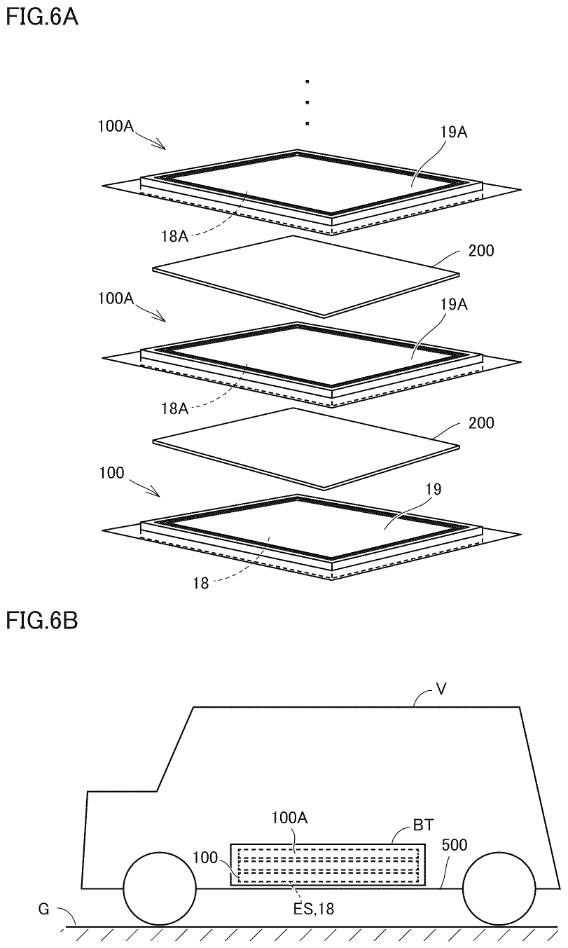

Each of FIGS. 6A and 6B is a diagram illustrating a battery pack BT including the battery module 100 and the bipolar battery module 100A. As illustrated in FIG. 6A, the battery module 100 and the bipolar battery module 100A are stacked between the second conductive plate 19 (positive electrode terminal) of the battery module 100 and the conductive plate 18A (negative electrode terminal) of the bipolar battery module 100A with a conductive member 200 being interposed therebetween. The bipolar battery module 100A is stacked between the conductive plate 18A (positive electrode terminal) and the conductive plate 19A (negative electrode terminal) with the conductive member 200 being interposed therebetween. The number of bipolar battery modules 100A may be any number, three, or ten. As illustrated in FIG. 6A, a battery pack BT is formed by connecting the battery module 100 and the bipolar battery module 100A in series to form a battery assembly and housing the battery assembly in a battery case (not illustrated).

As illustrated in FIG. 6B, the battery pack BT is mounted on the vehicle V and is disposed on the floor 500 of the vehicle V. The battery pack BT is disposed on the floor 500 of the vehicle V so that the first conductive plate 18 of the battery module 100 faces the road surface G (so that the first conductive plate 18 is vertically downward). Thus, the battery pack BT is mounted on the vehicle V such that the crushing-time discharging portion ES of the power storage device 1 faces the road surface G. Therefore, when the floor 500 of the vehicle V receives a large force due to road surface interference or the like, in the battery module 100, before the separator 15 inside the stacked electrode assembly 10 breaks and a short circuit occurs, the separator 15 in the region of the crushing-time discharging portion ES breaks and a short circuit occurs, and discharge is performed outside the stacked electrode assembly 10. As a result, the SOC of the stacked electrode assembly 10 decreases, and thus an excessive temperature rise of the battery pack BT (power storage device 1) can be suppressed.

In the above-described embodiment, in the power storage device 1, the negative-electrode termination electrode 17 and the uncoated portion of the electrode plate 11 extend in the stacking direction of the stacked electrode assembly 10 together with the adjacent separators 15, and are folded so as to be stacked on the positive-electrode termination electrode 16 with the separators 15 being interposed therebetween. A region in which the negative-electrode termination electrode 17 and the uncoated portion of the electrode plate 11 are folded so as to be stacked on the positive-electrode termination electrode 16 with the separator 15 interposed therebetween is used as the crushing-time discharging portion ES.

However, the uncoated portions of the positive-electrode termination electrode 16 and the electrode plate 11 may extend in the stacking direction of the stacked electrode assembly 10 together with the adjacent separators 15, and may be folded so as to be stacked on the negative-electrode termination electrode 17 with the separators 15 being interposed therebetween. In this case, a region in which the uncoated portions of the positive-electrode termination electrode 16 and the electrode plate 11 are folded so as to be stacked on the negative-electrode termination electrode 17 with the separator 15 interposed therebetween functions as the crushing-time discharging portion ES.

Although the present disclosure has been described and illustrated in detail, it is clearly understood that the same is by way of illustration and example only and is not to be taken by way of limitation, the scope of the present disclosure being interpreted by the terms of the appended claims.

What is claimed is:

1. A power storage device comprising:
a positive-electrode termination electrode that has a current collector having one surface on which a positive electrode active material layer is formed and that has an uncoated portion on which the positive electrode active material layer is not formed;
a negative-electrode termination electrode that has a current collector having one surface on which a negative electrode active material layer is formed and that has an uncoated portion on which the negative electrode active material layer is not formed; and
a stacked electrode assembly that has a bipolar electrode stacked between the positive-electrode termination electrode and the negative-electrode termination electrode with a separator being interposed between the bipolar electrode and each of the positive-electrode termination electrode and the negative-electrode termination electrode, wherein
the bipolar electrode has a current collector having one surface and the other surface on which the positive electrode active material layer and the negative electrode active material layer are formed respectively, and has an uncoated portion on which each of the positive electrode active material layer and the negative electrode active material layer is not formed,
the uncoated portion of one of the positive-electrode termination electrode and the negative-electrode termination electrode extends in a stacking direction of the stacked electrode assembly together with the separator adjacent to the uncoated portion of the one of the positive-electrode termination electrode and the negative-electrode termination electrode, and is folded so as to overlap with the other of the positive-electrode termination electrode and the negative-electrode termination electrode with the separator being interposed between the uncoated portion of the one of the positive-electrode termination electrode and the negative-electrode termination electrode and the other of the positive-electrode termination electrode and the negative-electrode termination electrode, and
the uncoated portion of the other of the positive-electrode termination electrode and the negative-electrode termination electrode and the uncoated portion of the bipolar electrode extend in the stacking direction of the stacked electrode assembly together with the separator adjacent to each of the uncoated portion of the other of the positive-electrode termination electrode and the negative-electrode termination electrode and the uncoated portion of the bipolar electrode, and are folded so as to be stacked on the one of the positive-electrode termination electrode and the negative-electrode termination electrode with the separator being interposed between each of the uncoated portion of the other of the positive-electrode termination electrode and the negative-electrode termination electrode and the uncoated portion of the bipolar electrode and the one of the positive-electrode termination electrode and the negative-electrode termination electrode.

2. The power storage device according to claim 1, wherein a thickness of the separator in a region folded so as to be stacked on the one of the positive-electrode termination electrode and the negative-electrode termination electrode is thinner than a thickness of the separator in a region included in the stacked electrode assembly.

3. A vehicle on which the power storage device according to claim 1 is mounted, wherein
the power storage device is mounted on a floor of the vehicle, and
the power storage device is disposed such that a side of the power storage device on which the uncoated portion of the other of the positive-electrode termination electrode and the negative-electrode termination electrode and the uncoated portion of the bipolar electrode are folded to be stacked on the one of the positive-electrode termination electrode and the negative-electrode termination electrode with the separator being interposed between the uncoated portion of the other of the positive-electrode termination electrode and the negative-electrode termination electrode and the uncoated portion of the bipolar electrode faces a road surface.

4. A vehicle on which the power storage device according to claim 2 is mounted, wherein
the power storage device is mounted on a floor of the vehicle, and
the power storage device is disposed such that a side of the power storage device on which the uncoated portion of the other of the positive-electrode termination electrode and the negative-electrode termination electrode and the uncoated portion of the bipolar electrode are folded to be stacked on the one of the positive-electrode termination electrode and the negative-electrode termination electrode with the separator being interposed between the uncoated portion of the other of the positive-electrode termination electrode and the negative-electrode termination electrode and the uncoated portion of the bipolar electrode faces a road surface.
